(19) United States
(12) Patent Application Publication
(10) Pub. No.: US 2002/0082163 A1
(43) Pub. Date: Jun. 27, 2002

(54) Reverse-layered, catalyzed adsorber system

(76) Inventors: JiYang Yan, Broken Arrow, OK (US); W. Burton Williamson, Broken Arrow, OK (US)

Correspondence Address: Vincent A. Cichosz, DELPHI TECHNOLOGIES, INC., 1450 West Long Lake, Troy, MI, 48007, US

(21) Appl. No.: 09/747,753

(22) Filed: Dec. 22, 2000

(51) Int. Cl. B01J 23/02; B01J 23/00

(52) U.S. Cl. 502/304; 502/325; 502/337; 502/339; 502/344; 502/345; 502/350; 502/355

(57) ABSTRACT

A reverse-layered, catalyzed adsorber system for treating exhaust gas comprises a catalyst washcoat supported by a catalyst substrate, with an adsorption material disposed over at least a portion of the catalyst washcoat. During the treatment of the hydrocarbons from an internal combustion engine exhaust, the adsorption material layer adsorbs hydrocarbons from the exhaust gas. A built-in catalyst layer later catalyzes the conversion of the hydrocarbons released from the adsorption material when the adsorber system is hot.

### TECHNICAL FIELD

The invention relates to catalytic converters for mobile vehicles and, more particularly, to a reverse-layered, catalyzed adsorber system for catalytic converters for mobile vehicles.

### BACKGROUND OF THE INVENTION

The purification of exhaust gases from internal combustion engines, particularly in mobile vehicles, is generally achieved by a catalytic converter in which a ceramic or metallic element having a honeycomb cell structure acts as a catalyst carrier. More precisely, this honeycomb cell structure or catalyst substrate is covered with a catalyst that contains a precious metal which functions, in the presence of exhaust gases to convert noxious or otherwise environmentally unfriendly components of the exhaust gas, such as hydrocarbons, carbon monoxide and nitrogen oxides, to carbon dioxide, water and nitrogen.

Conventional catalytic converters must be heated to approximately 250° C. before becoming operable to convert the combustion by-products, such as hydrocarbons, carbon monoxide and nitrogen oxides, of the internal combustion engine. A way to treat these engine combustion by-products before the catalytic converter becomes operable (e.g., temperatures up to 250° C.) is to temporarily store them in some adsorption material. They can be released later when the catalyst is ready to convert them. An adsorber that can store hydrocarbons for this purpose is called hydrocarbon adsorber. Furthermore, a hydrocarbon adsorber that also contains a catalyst, which can in situ convert the released hydrocarbon from adsorption material, is call a catalyzed hydrocarbon adsorber. When the engine is started, the hydrocarbon adsorption material adsorbs hydrocarbons from the exhaust gas stream at low temperatures (e.g., up to 250° C.), and releases them later at higher temperatures. In the meantime, the catalyst is heated by the hot exhaust and starts to catalyze the oxidation of the hydrocarbons emitted from the engine. As a net result, the emitted hydrocarbon is treated from the first second after the engine is started.

In the prior art of preparation of the catalyzed hydrocarbon adsorbers, the catalyst is either mixed with hydrocarbon adsorption material homogeneously, or is applied on top of the adsorber layer as a separate layer (e.g., layered, catalyzed hydrocarbon adsorbers). Several obstacles may be encountered in the prior art of preparation of the layered, catalyzed hydrocarbon adsorbers. For instance, obstacles such as limiting slurry pH, noble metal dispersion control, and the prevention of base metal leaching, etc., typically occur when applying the catalyst on top of the hydrocarbon adsorber layer. If these obstacles are not overcome, the layered, catalyzed adsorber quickly loses its performance (e.g., the adsorption material loses its adsorption capability; the adsorber releases hydrocarbon at a temperature lower than that the catalyst can properly function; and/or the catalyst starts to operate at a higher temperature). As a result, some (or even all) of the hydrocarbons will be returned to the exhaust stream and emitted to the atmosphere without being catalytically treated. Essentially, the overall performance of the catalyzed adsorber is adversely impacted.

For the internal combustion engine to meet stringent exhaust requirements, the catalytic converter must be more efficient. Consequently, there is a need for an apparatus and method for catalytically treating an exhaust gas stream.

### SUMMARY

The shortcomings and disadvantages of the prior art are overcome by the reverse-layered, catalyzed adsorber system, method for making the system, and method for treating exhaust gas. The reverse-layered, catalyzed adsorber system comprises: a catalyst washcoat supported by a catalyst substrate; and an adsorption material disposed on at least a portion of the catalyst material layer.

The method for manufacturing the reverse-layered, catalyzed adsorber system, comprises: supporting a catalyst washcoat with a catalyst substrate; covering at least a portion of the catalyst washcoat with an adsorption material such that the catalyst washcoat is disposed between the adsorption material and the catalyst substrate.

Finally, the method for treating exhaust gas, comprises: introducing exhaust gas to a catalytic converter assembly comprising the reverse-layered catalyzed adsorber system, wherein the catalytic converter comprises a shell concentrically disposed about a mat support material which is concentrically disposed about the catalyst substrate, and wherein the exhaust gas passes through the catalyst substrate. Hydrocarbons from the exhaust gas are first adsorbed when the converter is cold and then released and catalytically converted by the catalyst when the converter is hot.

### BRIEF DESCRIPTION OF THE DRAWINGS

Referring now to the figures, which are meant to be exemplary, not limiting, and wherein like elements are numbered alike in the several figures.

FIG. 1 is a cross-sectional view of an exemplary embodiment of one cell of a catalyst substrate having a reverse-layered, catalyzed adsorber.

FIG. 2 is side view of a catalytic converter.

FIG. 3 is a cross-sectional view taken along lines 3-3 of the catalytic converter shown in FIG. 2.

FIG. 4 is a bar graph illustrating hydrocarbon adsorption of non-catalyzed and catalyzed adsorbers (200 g/ft³ palladium) during Federal Testing Procedure 75.

FIG. 5 is a bar graph illustrating hydrocarbon desorption of non-catalyzed and catalyzed adsorbers (200 g/ft³ palladium) during Federal Testing Procedure 75.

### DESCRIPTION OF THE PREFERRED EMBODIMENT

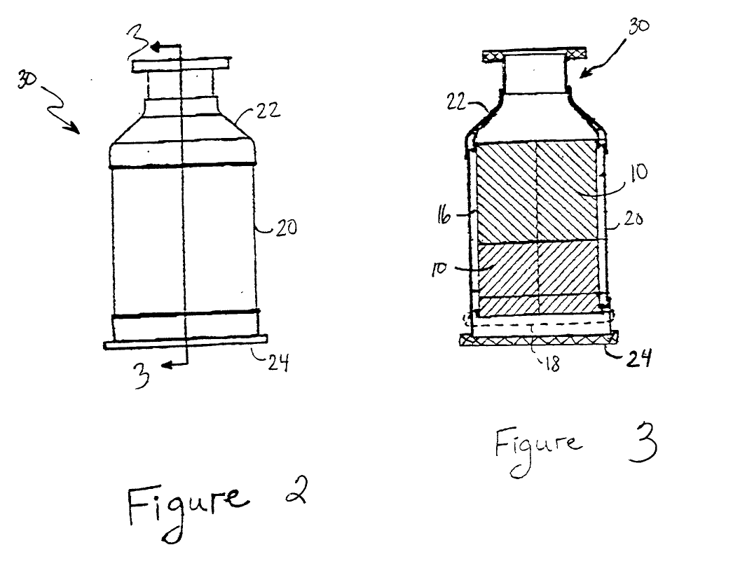

A reverse-layered, catalyzed adsorber for catalytically treating combustion engine exhaust gas of a mobile vehicle is disclosed herein. A catalytic converter comprises a catalyst supported by a catalyst substrate. The catalyst is disposed on a catalyst substrate, and underneath an adsorber layer to improve hydrocarbon desorption and catalyst light-off time. The catalyst substrate can then be disposed concentrically within a shell 20 (See FIG. 2) with a mat support material 16 (FIG. 3) disposed concentrically between the catalyst substrate and shell, and around the catalyst substrate to form a catalytic converter. An endcone 22 (See FIG. 3), an endplate 24, and/or an exhaust manifold cover can then be secured to the shell 20 containing the mat support material/catalyst substrate subassembly 18 to complete assembly of a catalytic converter 30 (See FIG. 3). The catalytic converter can be attached to an exhaust system component of an exhaust system for a mobile vehicle.

The catalyst substrate can comprise any material designed for use in a spark ignition or diesel engine environment. It should have the following characteristics: (1) capable of operating at temperatures up to about 1,000° C.; (2) capable of withstanding exposure to hydrocarbons, nitrogen oxides, carbon monoxide, carbon dioxide, water/steam, and/or sulfur; and (3) having sufficient surface area and structural integrity to support the desired catalyst. Some possible materials include cordierite, silicon carbide, metallic foils, alumina sponges, porous glasses, and the like, and mixtures comprising at least one of the foregoing. Some ceramic materials include “HONEYCERAM”, commercially available from NGK-Locke, Inc, Southfield, Mich., and “CELCOR”, commercially available from Corning, Inc., Corning, N.Y.

Although the catalyst substrate can have any size, cell density, or geometry, the size, cell density, and geometry are preferably chosen to optimize the surface area in the given converter design parameters. Typically, the catalyst substrate has a honeycomb cell geometry, with the cells being any multi-sided or rounded shape, with substantially square, hexagonal, octagonal or similar geometries preferred due to ease of manufacturing and increased surface area. Cell density should be optimized between the surface area and the mechanical strength of the substrate required by any specific application.

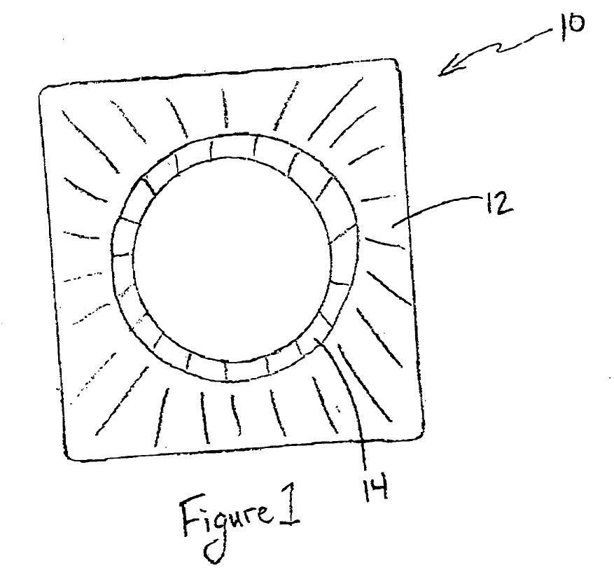

Disposed on and/or throughout the catalyst substrate can be a catalyst washcoat layer 12 (see FIG. 1) for converting exhaust gases to acceptable emissions levels as is known in the art. This washcoat layer can comprise a catalyst and a support. The catalyst may comprise one or more catalytic materials that are washcoated, imbibed, impregnated, physisorbed, chemisorbed, precipitated, or otherwise applied to the catalyst substrate. Possible catalyst materials include metals, such as platinum, palladium, rhodium, iridium, osmium, ruthenium, titanium, zirconium, yttrium, cerium, nickel, copper, and the like, as well as oxides, mixtures, and alloys comprising at least one of the foregoing metals, and other conventional catalysts.

Optionally combined with the catalyst, in the washcoat, can be materials such as support(s), promotor(s), stabilizer(s), binder(s), and the like. These materials optionally employed in the catalyst washcoat should be appropriate for combining or layering with the adsorption layer 14 (see FIG. 1). Possible materials include inorganic oxides such as alumina (e.g., delta phase alumina, gamma phase alumina, and the like), silica, titania, magnesia, zirconia, beryllia, lanthana, ceria, barium oxide, and the like; sulfates such as barium sulfate; as well as alloys and mixtures comprising at least one of the foregoing materials, with ceria, alumina, titania, and zirconia preferred. These materials can be employed in amounts of up to about 90 weight percent of the total weight of the catalyst washcoat.

Disposed on top of the catalyst washcoat layer and/or combined therewith can be an adsorption material layer 14 (see FIG. 1) for adsorbing hydrocarbons, water, and other combustion by-products in the exhaust gas stream. The adsorption material comprises one or more adsorption materials that are washcoated, or otherwise applied to the catalyst layer, and/or the catalyst substrate. Possible adsorption materials include zeolites, such as Beta, faujasites such as Y, Ferierite, and MFI (also known as “ZSM-5”), as well as inorganic oxides such as alumina, silica, titania, and the like; and mixtures comprising at least one of the foregoing materials, and other conventional adsorption materials.

Zeolites preferably retain their hydrocarbon adsorption capacity after being exposed to the exhaust gas components for up to 100,000 miles of vehicle operation. Typically, zeolites adsorb hydrocarbons at temperatures of about 0 to about 250° C., which typically characterizes cold start conditions. Cold start refers to the condition that the catalytic converter has not reached the operating temperatures, e.g., temperatures that the catalytic oxidation of hydrocarbon can take place. The catalyst must be heated to about 250° C. before it can catalyze the oxidation of the hydrocarbons from an internal combustion engine.

In an exemplary embodiment, the zeolite layer preferably adsorbs hydrocarbons from the exhaust gas stream at temperatures below 250° C. Zeolites preferably have the following characteristics: (1) capable of adsorbing hydrocarbon preferentially over water when exposed to exhaust gas streams under cold start condition; (2) preferably have a heat of adsorption value of at least about 9.5 kilocalaries per gram—mole (kcal/g-mol) of hydrocarbon adsorbed at about 150° C.; (3) capable of withstanding accelerated aging conditions, such as exposing a zeolite coated substrate to temperatures up to about 1000° C. for at least about 50 hours on an engine dynamometer, while still retaining both its adsorption properties and its structural integrity; (4) preferably does not dust, flake or spall once mixed with an inorganic binder and applied on a catalyst substrate as a coating.

The relative proportions of adsorption material and catalyst washcoat disposed on/throughout the catalyst substrate can vary widely with the adsorption material content being about 20 wt % to about 80 wt %, preferably about 40 wt % to about 60 wt %, based upon the combined adsorption material/washcoat weight.

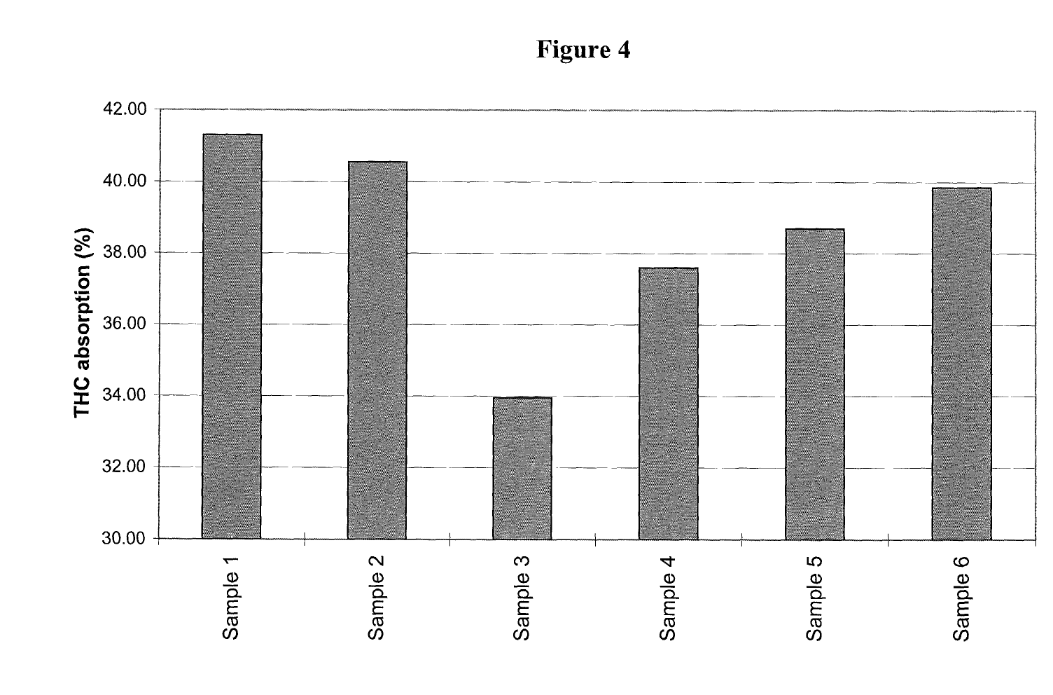

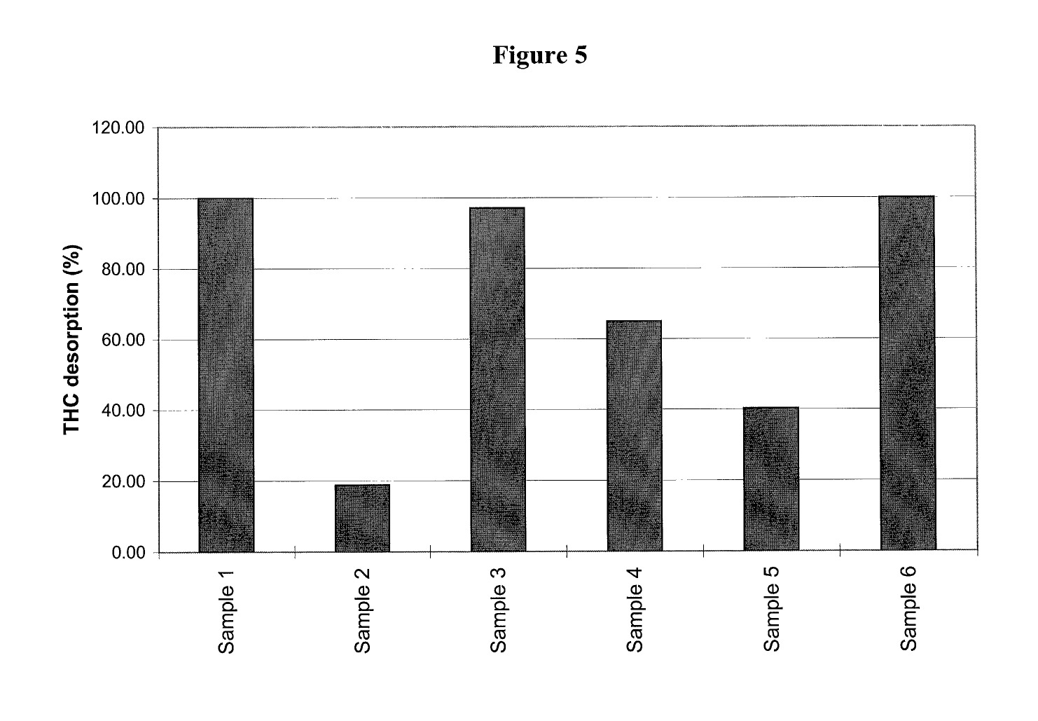

FIGS. 4 and 5 are bar graphs illustrating the percent total hydrocarbon (THC) adsorption and desorption of several non-catalyzed and catalyzed adsorbers. Conventional catalyzed adsorber systems are required to tolerate severe engine aging without significant loss of their hydrocarbon adsorption capability. An exemplary embodiment of the reverse-layered, catalyzed adsorber system was subjected an engine aging process to determine the reverse-layered catalyzed adsorber system's ability to tolerate severe thermal conditions. The engine aging is an accelerated aging process in which the catalyst substrate is treated on an engine dynamometer at temperatures much higher than typical operating temperatures experienced during vehicle driving. This is to simulate the damage that may incur by actual road driving conditions over about 50,000 miles to about 100,000 miles, with a much shorter time period, e.g., about 50 hours to about 100 hours. Aging is typically accelerated by using higher temperatures, e.g., up to about 1,000° C.

After the reverse-layered catalyzed adsorber system was aged, the catalytic system were tested under the Environmental Protection Agency's Federal Test Procedure 75 (hereinafter “FTP 75 test”) for determining vehicle emissions. The reverse-layered, catalyzed HC adsorber is compared with various prior art catalyzed HC adsorbers.

In prior art of layered, catalyzed HC adsorbers, the adsorber layer is first applied to the surface of the substrate. The catalyst washcoat containing the catalyst material is then disposed on top of the adsorption material layer. In that configuration, the catalyst material remains in fluid contact with the exhaust gas stream. However, after prolonged use and exposure to exhaust gas, diffusion barrier formation occurs between the catalyst washcoat layer and adsorption material layer. And thus, the adsorption capability of HC adsorber is lowered, as demonstrated by the results in FIG. 4.

It was demonstrated that the catalyst washcoat does not need to be in fluid contact with the exhaust gas stream. The catalyst washcoat can be disposed underneath the adsorption material, and still efficiently catalyze the exhaust gas. At the same time, the adsorption material layer demonstrates better hydrocarbon adsorption and desorption properties over prior art of catalyzed adsorber after aging. It was discovered that the aged, reverse-layered catalyzed adsorber system adsorbed a greater percentage of hydrocarbons from the exhaust gas stream, while desorbing and releasing a much lower percentage of hydrocarbons back into the exhaust gas stream without treatment.

The bar graph in FIG. 4 shows the hydrocarbon uptake, or adsorption, percentage of several non-catalyzed and catalyzed HC adsorbers during vehicle cold start conditions. Sample 1 is a reference that includes only a layer of zeolite and an inorganic binder material disposed on a catalyst substrate without a catalyst component(s) present. Sample 2 is a prior art of layered, catalyzed HC adsorber with a zeolite disposed beneath the catalyst layer. It provides a typical total hydrocarbon adsorption of about 40% to about 42% when fresh. Sample 3 is the sample 2 after the severe engine aging. It can be seen that Sample 3 experienced a significant impact in its hydrocarbon uptake capability, and only adsorbed about 34% of the total hydrocarbons. The reverse-layered catalyzed adsorbers, Samples 4-6 (with different catalyst compositions; wherein Sample 6 comprises the same composition as Sample 2, with the zeolite disposed over the catalyst layer), experienced minimum impact on their respective hydrocarbon uptake capabilities. Samples 4-6 provide a total hydrocarbon adsorption under severe engine aging conditions of about 37% to about 40%.

FIG. 5 is a bar graph illustrating the percent total hydrocarbon desorption back to exhaust (without conversion by catalyst) of the corresponding adsorbers demonstrated in FIG. 4. The catalyst light-off of an aged catalyst can be delayed so that the hydrocarbon oxidation (catalysis) does not take place before almost all of the hydrocarbons are released from the adsorption material (compare Sample 2 and Sample 3). A lower total hydrocarbon desorption percentage indicates an earlier catalyst light-off time, and a greater percentage of hydrocarbons that can be catalytically treated. Sample 1 is a reference, and includes only a zeolite layer and an inorganic binder disposed on a catalyst substrate without any catalyst material present. As depicted in FIG. 5, Samples 1, 3 and 6 release about 100% of the hydrocarbons back into the exhaust gas stream before the catalyst lights-off. The hydrocarbons are desorbed, released into the exhaust gas stream, and exit the mobile vehicle's tailpipe. In contrast, Samples 4 and 5, which are reverse-layered and have better catalysts than that in Sample 6, desorb about 40% to about 65% of the total hydrocarbons. These samples provide a significant improvement in net hydrocarbon conversion efficiency, than prior art of layered, catalyzed hydrocarbon adsorber (Sample 3).

Typically, as a catalyst washcoat catalyzes an exhaust gas stream over 50,000 to 100,000 miles of use, the catalyst material becomes densified. Once the catalyst material becomes dense, it can form a diffusion barrier. Then the adsorption material layer underneath is partially blocked and becomes less efficient in adsorbing hydrocarbons from the exhaust gas stream. Typically, conventional catalytic converters must be heated to approximately 250° C. before becoming operable to convert the combustion by-products of the internal combustion engine. However, as the aging severity increases, the catalyst light-off temperature may also increase beyond approximately 250° C. To accommodate diffusion barrier formation the thickness of the catalyst must be reduced. As a result, a limited amount of catalyst material can be used, which then adversely impacts and limits the incorporation of additional advanced light-off technologies such as using additional base metal mixed oxides for promoting nitrogen oxide reduction.

The reverse-layered, catalyzed adsorber system for treating internal combustion engine exhaust gas possesses several advantages over the prior art of non-layered and layered catalyzed adsorber systems. The reverse-layered, catalyzed adsorber maximizes the hydrocarbon adsorption capability of the adsorption material. The maximized hydrocarbon adsorption capability occurs due to the disposition of the adsorption layer on top of the catalyst material layer. The adsorption layer now remains in fluid contact with the exhaust gas stream so that a continuous adsorption/desorption occurs during operation of the catalytic converter.

The reverse-layered catalyzed adsorption system overcomes several coating obstacles experienced by conventional catalyzed adsorption systems. Such coating obstacles include limiting slurry pH, precious metal dispersion control, and the prevention of base metal leaching. By utilizing additional base metal oxides and inorganic binder material when applying the reverse-layered catalyzed adsorber system to a catalyst substrate, the pH of both the catalyst washcoat and adsorber system can be controlled. This can eliminate the likelihood that a precious metal and/or base metal oxide will leach into the adsorption material from the catalyst washcoat. This, in turn, eliminates the likelihood that the adsorption material's adsorption and desorption properties will be impaired over the lifetime of the catalytic converter.

For the reverse-layered catalyzed adsorber, the catalyst washcoat is applied to the catalyst substrate prior to applying the adsorption layer. Applying the adsorption material on the existing catalyst layer will not cause the coating obstacles experienced when applying the catalyst on an existing adsorption material layer. As a result, a greater surface area of the catalyst substrate can be utilized to support the catalyst.

The reverse-layered catalyzed adsorber system is less likely to have the diffusion barrier problem than typically experienced by prior art layered, catalyzed adsorber systems. This is because the adsorption materials normally have much higher porosity and are difficult to form into a diffusion barrier.

Importantly, advanced lightoff technologies, such as formulations containing oxygen storage components (base metal oxides) and structural stabilizers (for the stabilization of washcoat component(s) such as alumina), can optionally be incorporated into these reverse-layered, catalyzed HC adsorbers without coating limitations that are generally experienced in the coating of prior art of layered HC adsorbers.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A reverse-layered catalyzed adsorber system, comprising:
a catalyst washcoat supported by a catalyst substrate; and
an adsorption material disposed on at least a portion of the catalyst material layer.

2. The reverse-layered catalyzed adsorber system recited in claim 1,
wherein the catalyst washcoat further comprises a catalyst selected from the group consisting of platinum, palladium, rhodium, iridium, osmium, ruthenium, titanium, zirconium, yttrium, cerium, nickel, copper, and the like, and oxides, mixtures, and alloys comprising at least one of the foregoing metals.

3. The reverse-layered catalyzed adsorber system recited in claim 2,
wherein the catalyst washcoat further comprises a material selected from the group consisting of alumina, silica, titania, magnesia, zirconia, beryllia, lanthana, ceria, barium oxide, barium sulfate, and alloys and mixtures comprising at least one of the foregoing materials.

4. The reverse-layered catalyzed adsorber system recited in claim 3,
wherein the alumina is selected from the group consisting of delta phase alumina, gamma phase alumina, mixtures comprising at least one of the foregoing aluminas.

5. The reverse-layered catalyzed adsorber system recited in claim 3,
wherein the adsorption material further comprises a material selected from the group consisting of zeolites, alumina, silica, titania, and mixtures comprising at least one of the foregoing materials.

6. The reverse-layered catalyzed adsorber system recited in claim 1,
further comprising about 20 wt % to about 80 wt % adsorption material, based upon the total weight of the adsorption material and catalyst washcoat.

7. The reverse-layered catalyzed adsorber system recited in claim 6,
further comprising about 40 wt % to about 60 wt % adsorption material, based upon the total weight of the adsorption material and catalyst washcoat.

8. The reverse-layered catalyzed adsorber system recited in claim 6,
wherein the adsorption material further comprises a material selected from the group consisting of zeolites, alumina, silica, titania, and mixtures comprising at least one of the foregoing materials.

9. A method for manufacturing a reverse-layered catalyzed adsorber system, comprising:
supporting a catalyst washcoat with a catalyst substrate;
covering at least a portion of the catalyst washcoat with an adsorption material such that the catalyst washcoat is disposed between the adsorption material and the catalyst substrate.

10. The method for manufacturing the reverse-layered catalyzed adsorber system recited in claim 9, wherein the catalyst washcoat further comprises a catalyst selected from the group consisting of platinum, palladium, rhodium, iridium, osmium, ruthenium, titanium, zirconium, yttrium, cerium, nickel, copper, and the like, and oxides, mixtures, and alloys comprising at least one of the foregoing metals.

11. The method for manufacturing the reverse-layered catalyzed adsorber system recited in claim 10, wherein the catalyst washcoat further comprises a material selected from the group consisting of alumina, silica, titania, magnesia, zirconia, beryllia, lanthana, ceria, barium oxide, barium sulfate, and alloys and mixtures comprising at least one of the foregoing materials.

12. The method for manufacturing the reverse-layered catalyzed adsorber system recited in claim 9, wherein the adsorption material further comprises a material selected from the group consisting of zeolites, alumina, silica, titania, and mixtures comprising at least one of the foregoing materials.

13. The method for manufacturing the reverse-layered catalyzed adsorber system recited in claim 9, further comprising about 20 wt % to about 80 wt % adsorption material, based upon the total weight of the adsorption material and catalyst washcoat.

14. The method for manufacturing the reverse-layered catalyzed adsorber system recited in claim 13, further comprising about 40 wt % to about 60 wt % adsorption material, based upon the total weight of the adsorption material and catalyst washcoat.
